(19) United States
(12) Patent Application Publication
(10) Pub. No.: US 2016/0121544 A1
(43) Pub. Date: May 5, 2016

(54) METHOD OF PRODUCING A MEANS OF INTERMENT OR AT LEAST PART THEREOF

(71) Applicants: Andreas Einsiedel, Erlangen (DE); Philipp Hofmann, Furth (DE)

(72) Inventors: Andreas Einsiedel, Erlangen (DE); Philipp Hofmann, Furth (DE)

(21) Appl. No.: 14/831,136

(22) Filed: Aug. 20, 2015

(30) Foreign Application Priority Data
Nov. 5, 2014 (DE) 102014016278.8

(51) Int. Cl. B29C 67/00

(52) U.S. Cl. CPC B29C 67/0051; B29C 67/0092; B29C 67/0055; B33Y 10/00

(57) ABSTRACT

The invention relates to a method of producing a means of interment or at least part thereof, wherein at least one 3D printing apparatus is first produced, wherein the 3D printing apparatus is set up and provided in order to produce at least one three-dimensional object. In a following step, at least one printing material is introduced into a store of material, wherein individual printed layers, which are built up one upon the other and are stacked one upon the other in the printing direction and which are formed with the printing material in each case. According to the invention, the printing material is an environmentally compatible printing material, and the 3D printing apparatus forms the three-dimensional object, which is produced in particular in the form of a three-dimensional means of interment, by stacking the individual printed layers one above the other.

### CROSS REFERENCE TO RELATED APPLICATIONS

This application claims the benefit of German Patent Application No. DE 10 2014 016 278.8 to Andreas Einsiedel and Philipp Hofmann, entitled METHOD OF PRODUCING A MEANS OF INTERMENT OF AT LEAST PART THEREOF and filed on Nov. 5, 2014 which is hereby incorporated herein in its entirety by reference.

### SUMMARY

The present disclosure provides embodiments of methods and devices for interment utilizing 3D printing technologies. In some embodiments of a method incorporating features of the present invention, at least one 3D printing apparatus is produced, wherein the 3D printing apparatus is set up and provided in order to produce at least one three-dimensional object. At least one printing material is then introduced into a store of material. Next, individual layers are printed, which are built up one upon the other and are stacked one upon the other. The printing direction and that which is formed with the printing material in each case provide an advantage by producing printing material that is environmentally compatible. The 3D printing apparatus forms the three-dimensional object by stacking the individual printed layers one above the other.

In some embodiments, an apparatus incorporating features of the present invention comprises at least one 3D printing apparatus, wherein the 3D printing apparatus is set up and provided in order to produce at least one three-dimensional object, for example, a three-dimensional means of interment, such as a funerary urn or other structure for use in the burial of human or animal remains, by printed layers being stacked one upon the other. The apparatus further comprises at least one store of material, into which at least one printing material is capable of being introduced, wherein the printed layers are formed with the printing material, characterized in that the printing material is an environmentally compatible printing material and the three-dimensional object, is capable of being produced by means of the 3D printing apparatus, such as by utilizing the methods and devices described herein.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows a front sectional schematic view of one embodiment of the invention;

FIG. 2 shows a front cutaway schematic view of another embodiment of the invention;

FIG. 3 shows a front cutaway schematic view of a third embodiment of the invention;

FIG. 4 shows a front cutaway schematic view of a fourth embodiment of the invention;

FIG. 5 shows a front cutaway schematic view of a fifth embodiment of the invention; and

FIG. 6 shows a front schematic view of a sixth embodiment of the present invention.

### DETAILED DESCRIPTION

The present invention relates to a method of producing a means of interment or at least part thereof, a corresponding apparatus as well as a corresponding use thereof.

In particular, the present invention relates to such a method, in which a 3D printing apparatus is produced, the 3D printing apparatus being set up and provided in order to produce at least one three-dimensional object. In a further step, a printing material is introduced into a store of material, after which individual printed layers, which in particular are built up one upon the other and are stacked one upon the other in the printing direction and which are formed with the printing material.

However, 3D printing methods of this type are well known from the prior art. In this case 3D printing methods are understood as a blanket concept which represents an entire range of production techniques which function in accordance with differing principles. All the methods produce three-dimensional articles in this case, as they apply and solidify material in thin layers. The technical term for this is additive manufacturing, in contrast to subtractive techniques such as milling, sawing, drilling or water-jet cutting, which remove material.

By way of example, materials which become soft and moldable when heated, for example, thermoplastic materials such as acrylonitrile butadiene styrene (ABS) or polylactic acid (PLA), can be processed by means of so-called fused deposition modelling (FDM). The printing head of FDM machines essentially comprises a hot nozzle through which the solid raw material is pressed and is liquefied as a result. It issues as a thin and soft thread at the exit end of the nozzle. In this way, the printing head draws a layer of the desired article, the outer contour as a boundary line, and the faces are applied as shading. When the layer is completed and the material solidifies in the desired shape, the head moves away from the article by one layer thickness and draws the next layer.

In other words, “additive manufacturing” methods of this type are thus already well known. In addition, according to the prior art it has at best been possible until now to produce urns with biodegradable printing material (environmentally compatible material) which have been produced by conventional methods, for example in injection-molding methods. In other words, at the present time the known prior art provides no possibility of applying the advantages of a 3D printing method to the production of urns which have been produced for example from biodegradable printing materials.

Taking this as a starting point, an object of the present invention is to provide a method which makes it possible to produce a means of interment with an environmentally compatible material by means of a 3D printing method in a particularly simple, inexpensive and environmentally harmless manner. This therefore allows the combination of the advantages of a 3D printing method with the advantages of an environmentally harmless printing material in the field of interment.

In order to attain this object, the printing material is an environmentally compatible printing material and the 3D printing apparatus forms the three-dimensional object, which is produced in particular in the form of a three-dimensional means of interment, by stacking the individual printed layers one above the other.

In this context “environmentally compatible” means that the material (also printing material) is free of environmentally harmful substances, such as for example crude oil. In this case the material can also be a plastics material. In particular, the printing material has complete compatibility with the soil, organisms and water at the place of interment. In this respect, environmentally compatible materials can also be bio-compatible materials.

In accordance with at least one embodiment, the method described here comprises a first step in which at least one 3D printing apparatus is first produced, in which case the 3D printing apparatus is set up and provided in order to produce at least one three-dimensional object. In a further step a printing material is introduced into a store of material, after which individual printed layers, which are built up one upon the other and are stacked one upon the other in the printing direction and which are formed with the printing material in each case, are printed. According to the invention the printing material is an environmentally compatible printing material, the 3D printing apparatus forming the three-dimensional object, which is produced in particular in the form of a three-dimensional means of interment, by stacking the individual printed layers one above the other.

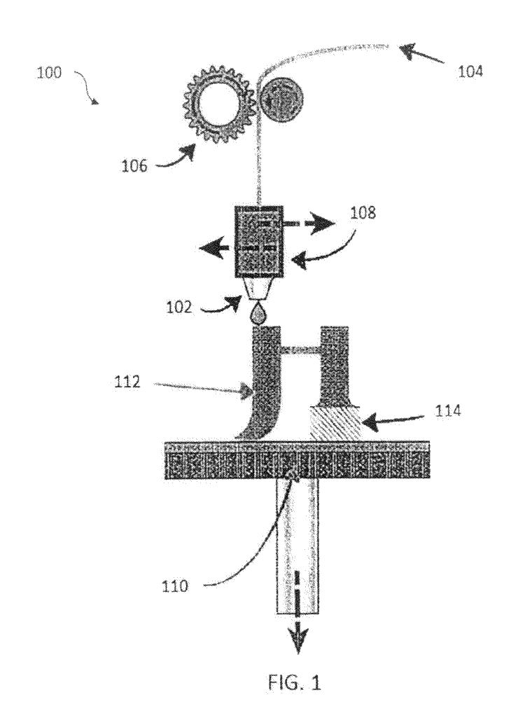

FIG. 1 shows a front sectional schematic view of one embodiment of the invention. The fused deposition modelling method illustrated by the apparatus 100 of FIG. 1 provides layers by extrusion of a material from a hot nozzle 102. The material used is in the form of a filament 104 such as is provided on a roll, and is fed by the conveying unit 106 into a printing head 108. The filament 104 is melted in the printing head 108, fed through the hot nozzle 102, and is distributed on a printing bed 110. The printing head 108 and the printing bed 110 can be movable in three directions in this case. In this way, layers of printed articles 112 can be applied stepwise one upon the other. The printed articles 112 can then be kept in a specific configuration, for example, a stepwise matter by a material portion 114, which can act as a support.

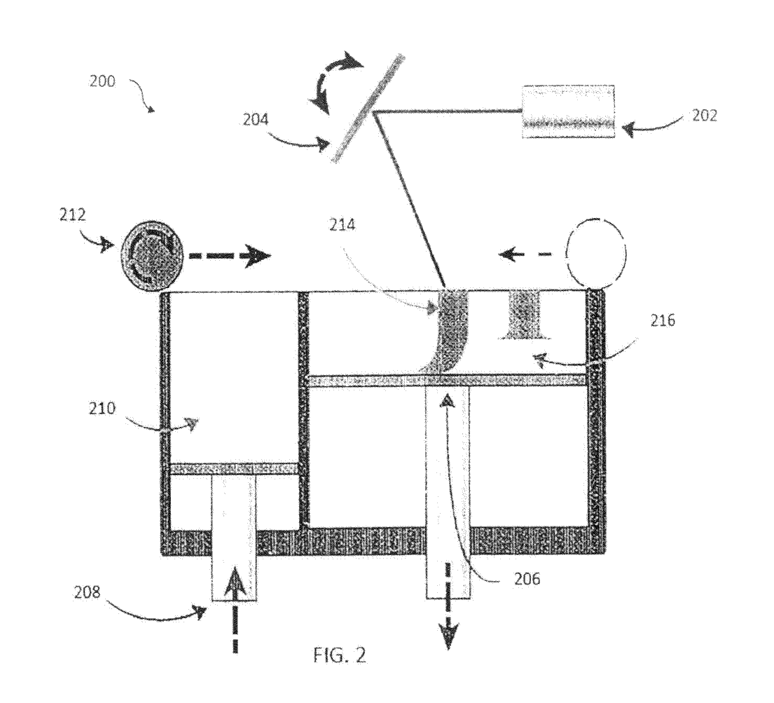

FIG. 2 shows a front cutaway schematic view of a second embodiment of the invention. In contrast to prior-described sintering methods, in which substances in the form of powder are joined to one another under the action of heat, in the present embodiment, a selective laser sintering method, as illustrated by the apparatus 200 shown in FIG. 2, is carried out selectively by use of a laser 202, or alternatively, by an electron beam, infrared beam, or similarly focused optical beam. The laser 202 provides energy directed into a deflecting mirror 204. The deflecting mirror 204 deflects the energy in the direction of the printing bed 206. In this way, only a specific part of powder is melted together (e.g. fused). To this end, some amount of powder is always supplied by a material supplier 208. The powder is then stored in a material storage area 210. A thin layer of power is thereafter distributed by the coating unit 212 onto the printing bed 206. The laser 202 (or other energy source) is now aligned in a highly precise manner with individual points of the layer of powder in order to form the first layer of the printed article 214. In this case, the powder is melted or fused and then solidifies again by slight cooling. The powder which has not melted remains lying around the sintered areas and acts as a support material 216. After a layer has solidified, the printing bed 206 is lowered by a distance, for example, a small distance such as a fraction of a millimeter. The coating unit 212 then moves over the printing bed 206 and distributes the next layer of powder. The second layer of the printed article 214 is then selectively sintered by the laser 202 (or other energy source). In this way, a three-dimensional object is produced in layers.

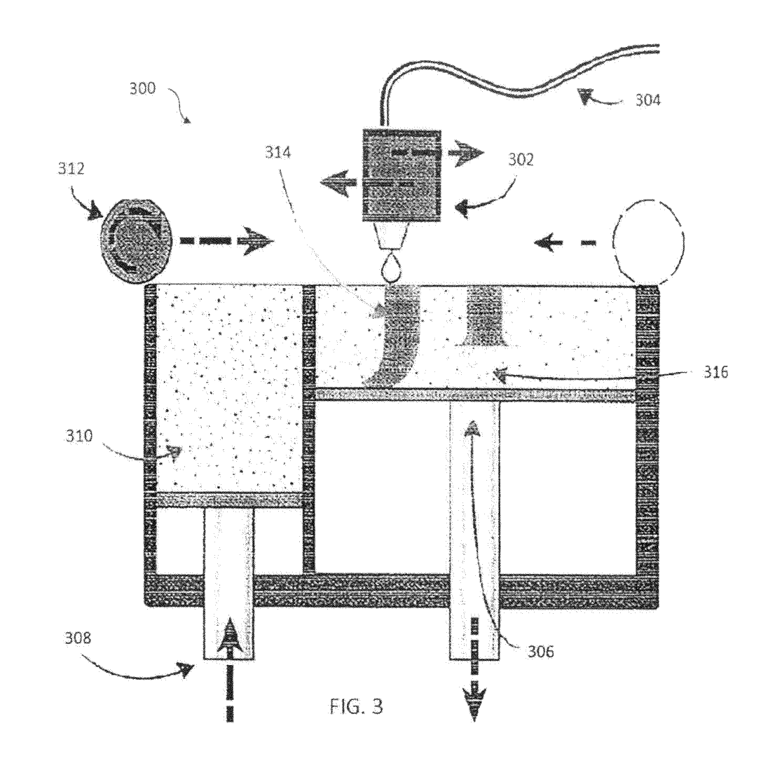

FIG. 3 shows a front cutaway schematic view of another embodiment of the invention. The 3D printing method illustrated by the apparatus 300 of FIG. 3 functions in a manner similar to the selective laser sintering illustrated by the apparatus 200 shown in FIG. 2, but instead of a directed energy source, a printing head 302 moves over the powder. The printing head 302 delivers tiny droplets of binder material 304 to a printing bed 306. To this end, like the selective laser sintering method illustrated in FIG. 2, some amount of powder is always supplied by a material supplier 308. The powder is then stored in a material storage area 310. A thin layer of powder from the material storage area 310 is then distributed by the coating unit 312 on the printing bed 306. The printing head 302 is now aligned in a highly precise manner with individual points of the layer of powder in order to form the first layer of the printed article 314. In this case, the powder utilizes a binder material which reacts or fuses. The powder which has not melted remains adjacent to the sintered areas and acts as a support material 316. After a layer has solidified, the printing bed 306 is lowered by a distance, for example, a small distance such as a fraction of a millimeter. The coating unit 312 now moves over the printing bed 306 and distributes the next layer of powder. After that, the second layer of the printed article 314 is removed by the printing head 302. In this way, a three-dimensional object is produced in layers.

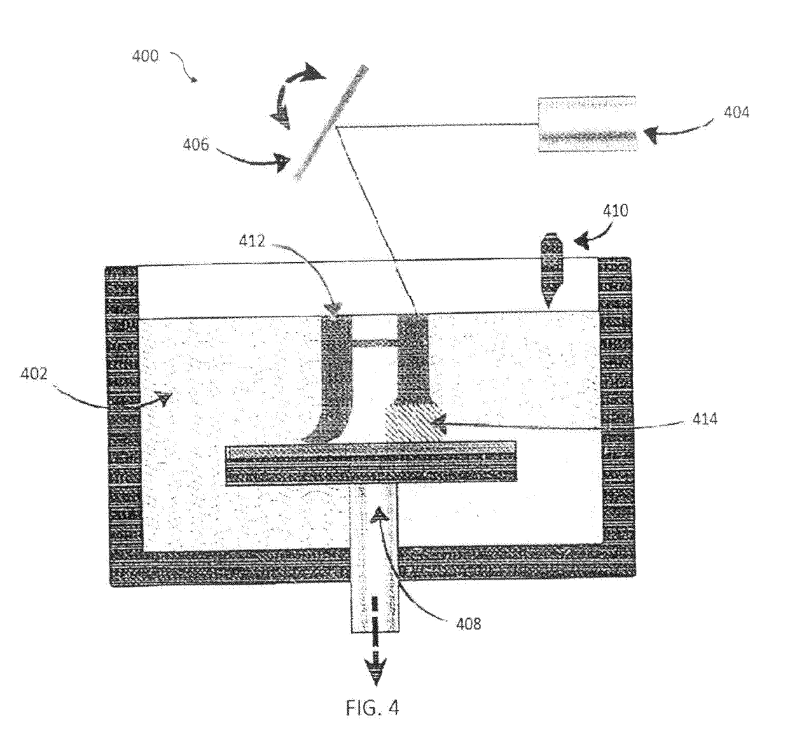

FIG. 4 shows a front cutaway schematic view of a still further embodiment incorporating features of the present invention. Instead of a filament of plastic material or a printing material in the form of powder, in the case of the stereolithography method as illustrated by the apparatus 400 of FIG. 4, the material comprises liquid resins 402, referred to as photopolymers. The photopolymers are selectively solidified in layers by UV radiation to produce three-dimensional articles. To supply UV radiation, a laser 404 providing energy may be directed into a deflecting mirror 406. The deflecting mirror 406 deflects the energy in the direction of the building platform 408. The building platform 408 is lowered stepwise in the liquid resin 402 as the photopolymer is solidified to form the 3D structure. A further thin layer of liquid resin 402 may then be distributed by the coating means 410 on the building platform 408 in order to form subsequent layers of the printed articles 412. The printed articles 412 are then formed and maintained in a specific configuration, for example, a stepwise manner, by a support 414. There are also variants (so-called polyjet methods) which do not utilize a basin completely filled with liquid resin 402. In such a procedure, an epoxy resin is applied dropwise from a nozzle and is immediately solidified by the laser 404.

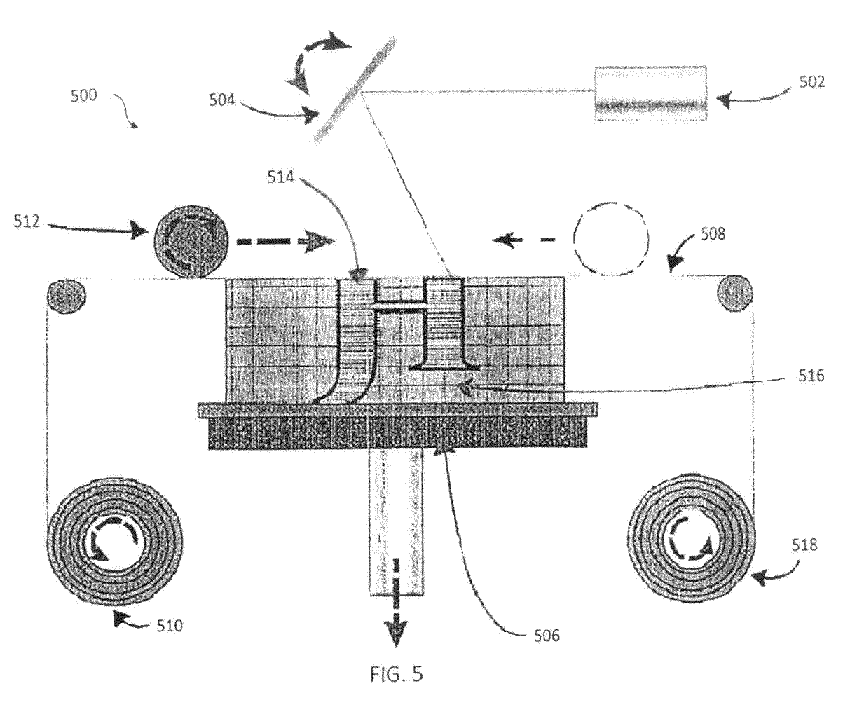

FIG. 5 shows a front cutaway schematic view of a fifth embodiment of the invention, using a laminated object manufacturing method illustrated by the apparatus 500 of FIG. 5. In this method, a laser 502 provides energy directed into a deflecting mirror 504. The deflecting mirror 504 deflects the energy in the direction of the building platform 506. In this way, a specific part of material is supplied. A film of material 508 is delivered from a supply roll 510. The film of material 508 is thereafter distributed by a heatable laminating roller 512 on the building platform 506. The laser 502 (or other energy source) is now aligned in a highly precise manner with individual locations on the film of material 508 in order to form the first layer of the printed article 514. In this case, the film of material 508 is cut on the contour with a cutting tool (not shown). For example, the cutting tool may be a knife or carbon dioxide laser. The remaining cut material 516 is glued in layers stacking one upon another. In this way, a layered article of glued films lying one upon the other is produced by lowering the building platform 506. The remaining cut material 516 may be attached to a material collection roll 518 located opposite of the supply roll 510.

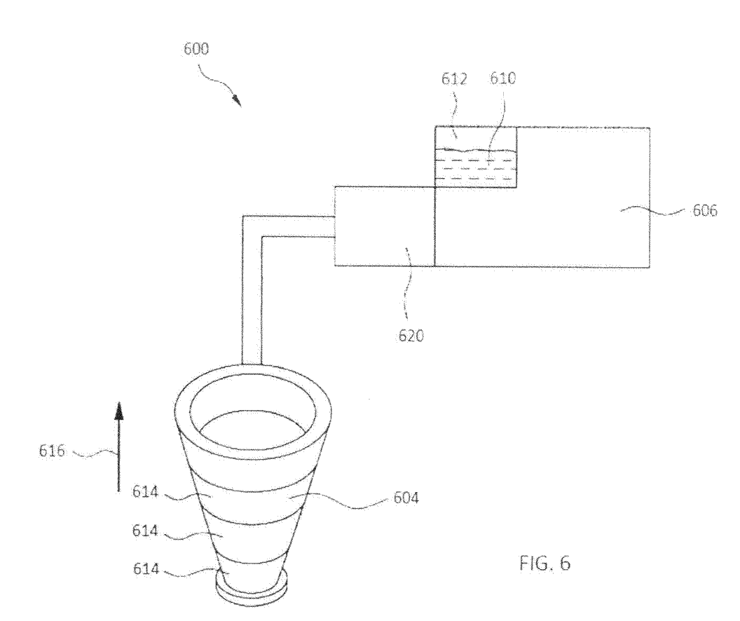

FIG. 6 shows a front section schematic view of one embodiment of the present invention. FIG. 6 comprises a further embodiment of an apparatus 600 for the production of a funerary urn 604. To this end, the method for the production of a funerary urn 604 comprises a first step which comprises the preparation of a 3D printing apparatus 606, the 3D printing apparatus 606 being set up and provided in order to produce at least one three-dimensional object. In a further step, a printing material 610 is introduced into a store 612 of material of the 3D printing apparatus 606, after which the printing of individual printed layers 614, are built up one upon the other and are stacked one upon the other in the printing direction 616 and are formed from the printing material 610.

As the apparatus 600 is intended for the production of burial structures, the apparatus 600 described herein and the method described herein for its use utilizes a printing material 610 that is an environmentally compatible printing material 610 and the 3D printing apparatus 606 forms the three-dimensional object, which is designed in particular in the form of a three-dimensional means of interment, by the individual printed layers 614 being stacked one upon the other.

In this case, the means of interment is designed in the form of a funerary urn 604. To this end, the 3D printing apparatus 606 comprises at least one printing element 620 by means of which the funerary urn 604 is produced. It is thus possible for funerary urns to be produced with biodegradable printing materials (environmentally compatible materials). In other words, the present invention offers the possibility of transferring the advantages of a 3D printing method to the production of funerary urns, and, in addition, to do this with an environmentally compatible material in order to meet the individual cemetery regulations.

In accordance with at least one embodiment, the printing material is bio-degradable. In every case “bio-degradable” refers to the ability of organic chemicals to decompose biologically, i.e. their decomposition by living creatures (in particular saprobionts) or the enzymes thereof. In an ideal case this chemical metabolism continues completely until mineralization, so that the organic compound is decomposed into inorganic substances such as carbon dioxide, oxygen and ammonia. However, the decomposition can also stop in the case of the formation of decomposition-stable transformation products.

In accordance with at least one embodiment the printing material is recyclable. The term “recycling” is defined, for example, as “any recovery method by which waste is processed into products, materials or substances either for the original purpose or for other purposes. It includes the processing of organic materials but not use as energy and the processing of materials which are intended for use as fuel or for filling” (Section 3, paragraph 25 of the German Recycling Law).

In accordance with at least one embodiment the printing material is compostable. “Composting” (also rotting) refers to the biological process of the nutrient cycle in which organic material capable of being easily processed is degraded under the influence of oxygen in the air (aerobically) of bacteria and fungi (heterotrophic micro-organisms). In this case, water-soluble mineral substances, for example, nitrates, ammonium salts, phosphates, potassium and magnesium compounds which act as fertilizers as well as carbon dioxide are also released. Part of the intermediate products formed during this degradation are converted into humus. One example of a material which is suitable in principle is PLA. PLA is recyclable and biologically degradable. PLA is a thermoplastic which is obtained from the starch of plants such as, for example, maize, sugar cane, grains or sugar beet. Produced under the right conditions (industrial composting at increased temperature and special environment) from biological resources this thermoplastic is biologically degradable, and toxicologically harmless for water and soil. Another example of a suitable material is BioFila® (lignin). BioFila is biologically degradable and compostable. BioFila is obtained from regrown raw materials (lignin) and is also biologically degradable. In particular, the material can decompose rapidly in the earth, and in particular more rapidly than in the rest times set in accordance with communal cemetery statutes. Yet another example of a suitable material is Algoblend® (algae). Algoblend is a natural substance, compostable with fertilizing effect. Finally, another suitable material is Sugar. Sugar is a 100% natural compostable substance.

In accordance with at least one embodiment the means of interment is designed in the form of a funerary urn or of at least part thereof. By way of example, an urn lid and/or even the main body of the urn is or are formed from a biologically degradable material.

In accordance with at least one embodiment the 3D printing apparatus comprises at least one printing apparatus which is suitable for and/or provided for producing an interment container in the form of a funerary urn or a part thereof.

In one preferred embodiment for the particular production of funerary urns, the metering element and, in particular, the sensor thereof can therefore be adapted only to the requirements for producing the urns. This can include a special adaptation to the quantity of material and/or the nature thereof in order to produce the funerary urn.

As an alternative to this, however, it is also possible for a 3D printer, as described in the introduction and known from the prior art, to be used for producing the funerary urns.

In addition, an apparatus for the production of a means of interment or at least part thereof is hereby also claimed. In particular, a method as described above can be carried out by means of the apparatus now claimed. This means that all the features disclosed for the method described here are also disclosed for the apparatus described here and vice versa.

In accordance with at least one embodiment, the apparatus for the production of a means of interment or at least part thereof comprises at least one 3D printing apparatus, the 3D printing apparatus being set up and provided in order to produce at least one three-dimensional object, in particular in the form of a three-dimensional means of interment, by printed layers being stacked one upon the other. In addition, the 3D printing apparatus can comprise at least one store of material, into which at least one printing material is capable of being introduced, in which case the printed layers are formed with the printing material and according to the invention the printing material is an environmentally compatible printing material and the three-dimensional object, in particular in the form of a three-dimensional means of interment, is capable of being produced by means of the 3D printing apparatus by the individual printed layers being stacked one upon the other.

In this case, the apparatus described here has the same advantages and designs as the method described here and vice versa. The method described here and the apparatus described here are explained in greater detail below with reference to an embodiment.

The same components or components functioning in the same way are provided in each case with the same references in the embodiments and the figure. The elements illustrated should not be regarded as being to scale, but rather individual elements can be shown exaggerated for improved understanding.

The invention is not restricted by the description with reference to the embodiment. In fact, the invention covers any novel feature and any combination of features, which in particular contains any combination of features in the claims, even if this feature or this combination itself is not indicated explicitly in the claims or the embodiment.

We claim:

1. A method of producing a means of interment or at least part thereof, comprising:
producing at least one 3D printing apparatus, wherein the 3D printing apparatus is set up and provided in order to produce at least one three-dimensional object;
introducing at least one printing material into a store of material; and
printing individual printed layers, which are built up one upon the other and are stacked one upon the other, in particular, in the printing direction and which are formed with the printing material in each case, characterized in that the printing material is an environmentally compatible printing material and the 3D printing apparatus forms the three-dimensional object, which is produced in particular in the form of a three-dimensional means of interment, by stacking the individual printed layers one above the other.

2. The method according to claim 1, characterized in that the printing material is biologically degradable.

3. The method according to claim 1, characterized in that the printing material is recyclable.

4. The method according to claim 1, characterized in that the printing material is compostable.

5. The method according to claim 1, characterized in that the means of interment is designed in the form of a funerary urn or in the form of at least part thereof.

6. The method according to claim 1, characterized in that the 3D printing apparatus comprises at least one printing element which is suitable and provided only for producing a means of interment in the form of a funerary urn or a part thereof.

7. An apparatus for the production of a means of interment or at least part thereof, comprising:
at least one 3D printing apparatus, wherein the 3D printing apparatus is set up and provided in order to produce at least one three-dimensional object, in particular in the form of a three-dimensional means of interment, by printed layers being stacked one upon the other; and
at least one store of material, into which at least one printing material is capable of being introduced, wherein the printed layers are formed with the printing material, characterized in that the printing material is an environmentally compatible printing material and the three-dimensional object, in particular in the form of a three-dimensional means of interment, is capable of being produced by means of the 3D printing apparatus by the individual printed layers being stacked one upon the other.

8. The apparatus according to claim 7 for the production of means of interment or at least part thereof, in particular of funerary urns or of at least part thereof.
